(19) United States
(12) Patent Application Publication
(10) Pub. No.: US 2006/0148955 A1
(43) Pub. Date: Jul. 6, 2006

(54) Rubber formulation and methods for manufacturing same

(75) Inventors: Olivier Leon-Marie Fernand Guiselin, Northboro, MA (US); Gwo Swei, Vandalia, OH (US); David Bravet, Shrewsbury, MA (US)

Correspondence Address: LARSON NEWMAN ABEL POLANSKY & WHITE, LLPL., 5914 WEST COURTYARD DRIVE, SUITE 200, AUSTIN, TX, 78746, US

(73) Assignee: SAINT-GOBAIN CERAMICS & PLASTICS, INC., Worcester, MA (US)

(21) Appl. No.: 11/288,945

(22) Filed: Nov. 29, 2005

Related U.S. Application Data
(60) Provisional application No. 60/632,116, filed on Dec. 1, 2004.
(60) Provisional application No. 60/632,644, filed on Dec. 2, 2004.

(51) Int. Cl. C08K 3/10

(52) U.S. Cl. 524/437

(57) ABSTRACT

A rubber composition includes nano-particulate filler and a coupling agent that includes at least one rubber reactive functional group and at least one filler reactive functional group. The filler reactive functional group includes one or more atoms selected from the group consisting of phosphorous, sulfur, titanium, zirconium, or aluminum.

### CROSS-REFERENCE TO RELATED APPLICATIONS

The present application claims priority from U.S. Provisional Patent Application No. 60/632,116, filed Dec. 1, 2004, entitled “RUBBER FORMULATION AND METHODS FOR MANUFACTURING SAME,” naming inventors Olivier Leon-Marie Fernand Guiselin, Gwo Swei, and David Bravet, which application is incorporated by reference herein in its entirety.

The present application claims priority from U.S. Provisional Patent Application No. 60/632,644, filed Dec. 2, 2004, entitled “RUBBER FORMULATION AND METHODS FOR MANUFACTURING SAME,” naming inventors Olivier Leon-Marie Fernand Guiselin, Gwo Swei, and David Bravet, which application is incorporated by reference herein in its entirety.

### FIELD OF THE DISCLOSURE

This disclosure, in general, relates to rubber formulations and methods for manufacturing same.

### BACKGROUND

Worldwide, the tire industry represents a vast market: in 2003 tire sales exceeded 75 billion dollars. Within this market, over 80% of tire sales are for truck and passenger car tire applications. Due largely to the expected service life of modern vehicles, a typical passenger car or truck may consume multiple sets of tires during its service life. Accordingly, within the passenger car and truck tire market, the majority of tire sales is driven by tire replacement, and in the context of the truck industry, oftentimes retread.

In addition to the strong demand for passenger car and truck tires worldwide, the tire market has sought to blend desirable characteristics into a single tire, oftentimes these characteristics being somewhat exclusive of each other. For example, the tire industry simultaneously demands tight price control, long service life, high fuel efficiencies, low acoustic signatures, high levels of adhesion and grip (wet and dry), high levels of road handling, high speed ratings, and high load capacity. Of course, certain characteristics are emphasized within different applications; for example, desired characteristics of high performance passenger car tires may differ considerably from the desired characteristics commercial truck tires.

In an attempt to meet rising demands within the passenger car tire industry, recent developments in “green tire” technologies have provided a notable improvement in (i) lowered rolling resistance and attendant reduction in fuel consumption, (ii) adhesion and grip in wet conditions for improved safety, and (iii) service life and wear resistance. The so-called green tire technology generally relies on highly dispersible (HD) silica in conjunction with bi-functional silane coupling agents. Green tire technology has been so well received, it is estimated that 80% of the original equipment manufacturer (OEM) market in Europe has been dominated by this technology. The shift from conventional carbon black-based technology to green tire technology demonstrates the demand for improved tire formulations in the market.

In order to meet such intense demands by the industry, reinforcing fillers, such as carbon black or precipitated silica (including HD silica), have become desirable in modern tire formulations. Such fillers allow dramatic improvement of abrasion and wear resistance thereby extending service life, improvement in tensile strength and tear resistance, and improvement in tensile modulus and hardness contributing to tire robustness. On the other hand, fillers can have adverse effects on tire dynamic properties such as rolling resistance and wet grip, and negatively impact compound viscosity and curing time, negatively impacting productivity and cost.

As should be clear from the foregoing, the tire industry is highly receptive to improved tire formulations meeting the oftentimes contradictory objectives discussed above. In particular, the industry is receptive to rubber formulations that are particularly useful for tire applications that take advantage of reinforcing fillers.

### SUMMARY

In a particular embodiment, a rubber composition includes nano-particulate filler and a coupling agent that includes at least one rubber reactive functional group and at least one filler reactive functional group. The filler reactive functional group includes one or more atoms selected from the group consisting of phosphorous, sulfur, titanium, zirconium, or aluminum.

In another exemplary embodiment, a rubber formulation includes aluminous particles and a coupling agent including a sulfonic filler reactive functional group.

In a further exemplary embodiment, a rubber formulation includes aluminous particulate filler and a coupling agent having a titanate functional group.

In an additional exemplary embodiment, a rubber formulation includes aluminous particulate filler and a coupling agent having a zirconate functional group.

In another exemplary embodiment, a rubber composition includes nano-particulate filler including aluminum oxide-hydroxide material that conforms to the formula Al(OH)ₐO_{b}, with the exception of any impurities, wherein 0≦a≦3 and b=(3−a)/2. The nano-particulate filler has an aspect ratio of not less than 2:1. The rubber composition also includes a coupling agent that includes at least one rubber reactive functional group and at least one filler reactive functional group. The filler reactive functional group includes one or more atoms selected from the group consisting of sulfur, titanium, zirconium, or aluminum.

In a further exemplary embodiment, a tire includes a composite material including a cross-linkable elastomeric material and nano-particulate filler dispersed in the cross-linkable elastomeric material. The nano-particulate filler includes aluminum oxide-hydroxide material that conforms to the formula Al(OH)ₐO_{b}, with the exception of any impurities, wherein 0≦a≦3 and b=(3−a)/2. The nano-particulate filler has an aspect ratio of not less than 2:1.

In an additional exemplary embodiment, a method of manufacturing rubber formulations includes mixing nano-particulate filler with a coupling agent having a filler reactive functional group. The filler reactive functional group includes one or more atoms selected from the group consisting of sulfur, titanium, zirconium, or aluminum. The method further includes drying the mixture to form a rubber reactive filler.

In a further exemplary embodiment, a method of forming a rubber composition includes mixing diene precursors, nano-particulate filler, and a coupling agent to form a mixture. The coupling agent includes at least one rubber reactive functional group and at least one filler reactive functional group. The filler reactive functional group includes one or more atoms selected from the group consisting of phosphorous, sulfur, titanium, zirconium, or aluminum. The method further includes curing the mixture.

### DESCRIPTION OF THE PREFERRED EMBODIMENT(S)

In a particular embodiment, the disclosure is directed to a rubber composition including nano-particulate filler and a coupling agent. The coupling agent has at least one rubber reactive functional group and at least one filler reactive functional group. In an exemplary embodiment, the rubber composition includes a curable elastomer that is sulfur curable. In another exemplary embodiment, the curable elastomer is peroxide curable. The filler includes an element being selected from the group consisting of Al, Sn, In, Sb, transition metals, or a mixture of these elements. The filler may be seeded aluminum oxide-hydroxide filler, particularly including anisotropic nano-particulate primary particles. Turning to the coupling agent, the rubber reactive functional group may include sulfur. Alternatively, the filler reactive functional group includes a derivative of phosphonic acid, phosphinic acid, phosphoric acid ester, phosphoric acid di-ester, sulfonic acid, titanate, zirconate, aluminate, or aluminozirconate.

The disclosure is also directed to a method of manufacturing a rubber composition. The method includes mixing a coupling agent with nano-particulate filler to form a mixture and drying the mixture to form a rubber reactive filler. The dried mixture is added to rubber precursors and the rubber is cured. Alternatively, dried nano-particulate filler, coupling agent, and the rubber precursors may be mixed prior to curing.

The rubber composition generally includes an elastomeric polymer. Elastomeric polymers are those polymers that when deformed (stretched, twisted, spindled, mutilated, etc.), spring back into their original shape. One exemplary elastomer is lightly-crosslinked natural rubber. Other elastomeric polymers include polyolefin, polyamide, polyurethane, polystyrene, diene, silicone, fluoroelastomer, and copolymers, block copolymers, and blends thereof. Specific polymers that may be formulated as elastomeric materials include acrylonitrile butadiene styrene (ABS), ethylene propylene diene monomer rubber (EPDM), fluoroelastomer, polycaprolactam (nylon 6), and nitrile butadiene rubber (NBR).

The elastomeric polymer may be cured through crosslinking, such as through vulcanization. In one particular embodiment, the elastomeric polymer is curable using sulfur-based agents, such as at least one of elemental sulfur, polysulfide, and mercaptan. In another embodiment, the elastomer is curable using peroxide-based agents, such as metallic peroxides and organic peroxides. In a further example, the formulation is curable using amine-based agents.

In one particular embodiment, the elastomeric polymer includes diene elastomers. “Diene” elastomer or rubber is understood to mean an elastomer resulting at least in part (i.e., a homopolymer or a copolymer) from diene monomers (monomers bearing two double carbon-carbon bonds, whether conjugated or not).

Exemplary diene elastomers include:

(a) homopolymer obtained by polymerisation of a conjugated diene monomer having 4 to 12 carbon atoms;

(b) copolymer obtained by copolymerisation of one or more dienes conjugated together or with one or more vinyl-aromatic compounds having 8 to 20 carbon atoms;

(c) ternary copolymer obtained by copolymerisation of ethylene, of an alpha-olefin having 3 to 6 carbon atoms with a non-conjugated diene monomer having 6 to 12 carbon atoms, such as, for example, the elastomers obtained from ethylene, from propylene with a non-conjugated diene monomer of the aforementioned type, such as in particular 1,4-hexadiene, ethylidene norbornene or dicyclopentadiene; and

(d) copolymer of isobutene and isoprene (butyl rubber), and also the halogenated, in particular chlorinated or brominated, versions of this type of copolymer.

Unsaturated diene elastomers, in particular those of type (a) or (b) above, are particularly adaptable for use in tire tread. Conjugated dienes include 1,3-butadiene, 2-methyl-1,3-butadiene, 2,3-di(C₁-C₅ alkyl)-1,3-butadienes such as, for instance, 2,3-dimethyl-1,3-butadiene, 2,3-diethyl-1,3-butadiene, 2-methyl-3-ethyl-1,3-butadiene, 2-methyl-3-isopropyl-1,3-butadiene an aryl-1,3-butadiene, 1,3-pentadiene and 2,4-hexadiene. Vinyl-aromatic compounds include, for example, styrene, ortho-, meta- and para-methylstyrene, the commercial mixture “vinyltoluene”, para-tert butylstyrene, methoxystyrenes, chlorostyrenes, vinylmesitylene, divinylbenzene and vinylnaphthalene.

The diene elastomer of the composition may be selected from the group of highly unsaturated diene elastomers, which consists of polybutadienes (BR), synthetic polyisoprenes (IR), natural rubber (NR), butadiene-styrene copolymers (SBR), butadiene-isoprene copolymers (BIR), butadiene-acrylonitrile copolymers (NBR), isoprene-styrene copolymers (SIR), butadiene-styrene-isoprene copolymers (SBIR), and mixtures of these elastomers.

In one particular embodiment, the rubber composition is useful for a tread for a tire, be it a new or a used tire (case of recapping). When such a tread is intended for example for a passenger-car tire, the diene elastomer is, for example, an SBR or an SBR/BR, SBR/NR (or SBR/IR), or alternatively BR/NR (or BR/IR) blend (mixture).

When the tread is intended for a utility tire such as a heavy-vehicle tire, the diene elastomer is preferably an isoprene elastomer. “Isoprene elastomer” includes an isoprene homopolymer or copolymer, in other words a diene elastomer selected from the group consisting of natural rubber (NR), synthetic polyisoprenes (IR), the various isoprene copolymers and mixtures of these elastomers. Isoprene copolymers include isobutene-isoprene copolymers (butyl rubber—IIR), isoprene-styrene copolymers (SIR), isoprene-butadiene copolymers (BIR) or isoprene-butadiene-styrene copolymers (SBIR). Alternatively, the diene elastomer is formed, at least in part, by a highly unsaturated elastomer such as, for example, an SBR elastomer.

In another example, the composition contains at least one essentially saturated diene elastomer, such as at least one EPDM copolymer. In further exemplary embodiments, the rubber composition contains a single diene elastomer or a mixture of several diene elastomers, the diene elastomer or elastomers possibly being used in association with any type of synthetic elastomer other than a diene elastomer, or even with polymers other than elastomers, for example thermoplastic polymers.

Generally, the rubber composition is compounded by methods generally known in the rubber compounding art, such as mixing various vulcanizable constituent rubbers with various commonly used additive materials such as, for example, curing aids, such as sulfur, activators, retarders and accelerators, processing additives, such as oils, resins including tackifying resins, and plasticizers, fillers, pigments, fatty acid, zinc oxide, waxes, antioxidants and antiozonants, peptizing agents and reinforcing materials such as, for example, carbon black.

Generally, the particulate fillers described below act as reinforcing materials. Exemplary fillers include metal oxides and hydroxides. For example, the particulate filler may be an aluminum-containing ceramic, such as aluminum oxides and hydroxides, and alumino silicates. Aluminum oxides and hydroxides include transitional alumina, such as gamma alumina, aluminum trihydrates, diaspore and boehmite. Generally, aluminum oxides and hydroxides can be expressed by the formula Al(OH)ₐO_{b}, where 0≦a≦3 and b=(3−a)/2. By way of example, when a=0 corresponds to alumina (Al₂O₃) and a=1 corresponds to boehmite. Alumino silicates include, for example, hydrated alumino silicate, such as allophane, non-hydrated alumino silicate such as andalusite, sodium/potassium alumino silicate such as nepheline, hydrated sodium alumino silicate such as analcime.

Other exemplary embodiments include metal oxides, such as iron oxide, titanium dioxide and zirconia, and metal hydroxides, such as magnesium hydroxide and goethite. In another exemplary embodiment, the particulate filler includes carbon black that has been coated with metal oxides and hydroxides, such as aluminum hydroxides and oxides, titanium dioxide, and zirconium dioxide.

For example, the particulate filler may have a composition, which includes oxygen and at least one element selected from the group comprising Al, Sn, In, Sb, Mg, transition metals, or a mixture of these elements. In one exemplary embodiment, with the exception of any impurities, the particles correspond to the general formula Mₓ A_{y} Si_{z} O_{b} (OH)ₐ (H₂O)_{c} (X)_{d} where
x≧0, y≧0, z≧0, a≧0, b≧0, (a+b)>0, c≧0, d≧0,
M being selected from the group comprising Na+, K+, Ca++, Mg++, Ba++ or a mixture of this cations,
A being selected from the group comprising Al, Sn, In, Sb, transition metals, or a mixture of these metals,
X being selected from the group comprising F⁻, Cl⁻, Br⁻, I⁻, CO3⁻², SO4⁻², PO4⁻³, NO₃⁻, other anions, or a mixture of these anions.

In an exemplary embodiment, the particulate filler comprises an hydrated aluminosilicate which corresponds, with the exception of any impurities, to the general formula Al_{y} Si_{z} O_{b} (OH)ₐ (H₂O)_{c} where y>0, z>0, a≧0, b≧0, (a+b)>0, c≧0. In one particular embodiment, the ratio (moles of Al/moles of Si) is higher than 1/4 and preferably higher than 1/2, 1/1, or even 2/1.

The morphology of the particulate material may be defined in terms of primary particle size, more particularly, average primary particle size. The particulate material may have a relatively fine particle or crystallite size. As used herein, the “average particle size” is used to denote the average longest or length dimension of the primary particles. Due to the elongated morphology of particles according to certain embodiments (covered in more detail below), conventional characterization technology is generally inadequate to measure average particle size, since characterization technology is generally based upon an assumption that the particles are spherical or near spherical. Accordingly, average particle size was determined by taking multiple representative samples and physically measuring the particle sizes found (longest dimension) in representative samples. Such samples may be taken by various characterization techniques, such as by scanning electron microscopy (SEM). The term average particle size also denotes primary particle size, related to the individually identifiable particles, whether as dispersed or agglomerated forms.

Generally, the average particle size is not greater than about 1000 nanometers, and falls within a range of about 10 to 1000 nanometers. Other embodiments have even finer average particle sizes, such as not greater than about 400 nanometers, not greater than about 200 nanometers, 100 nanometers, and even particles having an average primary particle size smaller than 50 nanometers, representing a fine particulate material.

In some cases, due to process constraints of certain embodiments, the smallest average particle size is limited, such as not less than about 5 nanometers, not less than about 10 nanometers, not less than about 75 nanometers, not less than about 100 nanometers, or not less than about 125 nm. For example in the case of platy seeded aluminum oxide-hydroxide particles the minimum average primary particle size is typically 100 nm.

In addition to average particle size of the particulate material, morphology of the particulate material may be further characterized in terms of specific surface area. Here, the commonly available BET technique is utilized to determine specific surface area of the particulate material. According to embodiments herein, the particulate material has a relatively high specific surface area, generally not less than about 10 m²/g, such as at least about 25 m²/g, at least about 30 m²/g, at least about 70 m²/g, or at least about 90 m²/g. Since specific surface area is a function of particle morphology as well as particle size, generally the specific surface area of embodiments is not greater than about 400 m²/g, such as not greater than about 350 m²/g or not greater than about 300 m²/g. A specific range for surface area is about 30-300 m²/g.

Morphology of the particulate material may further be characterized in terms of density. In the case of aluminous materials, the density of the particulate material is, for example, at least about 0.35 g/cc, such as at least about 0.38 g/cc or at least about 0.40 g/cc.

The particulate material is generally formed through a seeded processing pathway, which takes advantage of heat treatment of at least one solid particulate precursor into a desired particulate product. Typically, processing takes advantage of hydrothermal processing of a precursor at elevated temperatures and pressures in the presence of a fine seed material that provides nucleation and growth centers for conversion or consumption of the precursor. In some cases, the hydrothermal process does not require pressure control, and can be done at 1 atmosphere. However in many cases, pressure control is preferable. Hydrothermal processing involves a dissolution/reprecipitation reaction, and reprecipitation occurs around the seeds. The material precursors of the final particles generally comprise one or several minerals, ions, or gas species Ai (1≦i≦n) that are dispersed or in solution in water. Mineral species are made of solid particles dispersed in the solution that should not be too coarse to facilitate the dissolution process. At least one material precursor (for example A1) should be a mineral species. The material precursors generally re-precipitate around the seeds Sj (1≦j≦L) to form one or several new materials Bj (1≦j≦m) according to the following reaction:

$$A 1 + … + An + y H 2 O + energy {\to }_{S 1 + … + SL} B 1 + … + Bm + x H 2 O \qquad ( I )$$

where: n≧1, y≧0, m≧L≧1, and x≧0 with preferably y=0 and L=m.

In reaction (I) the new materials Bk (1≦k≦L) correspond to the product of the precipitation reaction around the seeds Bk (1≦k≦L). In the case m>L, the new materials Bk (L+1≦k≦m) can be solid particles, or soluble species. Such species can be by-products that can be washed away or can be a desired component of the final particulate material. In general, L is equal to 1 to generate a single type of primary particles. Alternatively, L can be equal to 2 or higher to generate a mixture of at least two different types of nano-particles. For example, in some rubber applications, it may be desirable to reduce filler-filler interactions and filler networking tendency. Such can be accomplished using different fillers with different surface chemistry. Of course, the different fillers can be blended during the compounding operations. However each aggregate/agglomerate within the rubber would be made of a single type of primary particles. The process (with L≧2) offers the possibility to produce aggregates made of at least two different types of primary particles. In addition during the drying process, the different primary particles are less likely to form strong agglomerates, which are difficult to disperse in the polymer formulation.

Several chemical additives such as acids, bases, phosphates, sulfate, carbonates, amines, or polymers can be used alone or in combination to modify the dissolution/precipitation process or to stabilize the initial material precursor dispersion. However, certain additives can also inhibit the process.

The process is preferably performed in water. Alternatively, a co-solvent such as alcohol can be added to water. Other polar solvents, or a combination of several solvents can also be used.

Following hydrothermal treatment, the liquid content is generally removed, through a process that limits agglomeration of the particles upon elimination of water, such as freeze drying, spray drying, or other techniques to prevent excess agglomeration. In certain circumstances, ultrafiltration processing or heat treatment to remove the water may be used. Thereafter, the resulting mass may be crushed, such as to 100 mesh. It is noted that the particulate size described herein generally describes the single crystallites/primary particles formed through processing, rather than any aggregates/agglomerate, which may remain in certain embodiments. The seeded particulate material, prior to incorporation into the rubber composite, may be a mass of particulate material, composed of particles that may be fully dispersed, partially agglomerated, or fully agglomerated. The final particulate material generally includes the primary particles formed during the hydrothermal process, the aggregates made of primary particles which are strongly bonded together, and the agglomerates made of aggregates or/and primary particles which are weakly bonded together.

According to embodiments, the composition of the seeded particulate material may vary, and can include primary particles of iron oxide, hydrated sodium/potassium/calcium alumino silicate, alumino silicate hydroxide, or mixture of different minerals. For example, seeded nano-hematite (Fe₂O₃) can be produced using goethite FeO(OH) as a material precursor. The conversion of hematite into goethite is preferably performed at a temperature higher than 100° C. and a pressure higher than 5 bars. Notably, the seeded particulate material may be an aluminum-containing ceramic material.

In the context of hydrated sodium/potassium/calcium alumino silicate, one embodiment calls for a seeded analcime. Analcime is a zeolite which has the following chemical formula Na Al Si₂ O₅ (OH)₂. Analcime is sometimes known as analcite, although analcime is preferred. Analcime's structure however has a typical zeolite openness that allows large ions and molecules to reside and actually move around inside the overall framework. The structure includes large open channels that allow water and large ions to travel into and out of the crystal structure. The size of these channels controls the size of the molecules or ions, and therefore a zeolite like analcime can act as a chemical sieve. In some composition, a fraction of the sodium is replaced by potassium and/or calcium. Thus, a more general formula is (Na, K, ½ Ca)₁ Al Si₂ O₅ (OH)₂.

Na-Clinoptilolite is a zeolite having a simplified chemical formula, Na Al Si₅ O₈ (OH)₈. However, a fraction of the sodium can be replaced by potassium and/or calcium. Thus, a more general chemical formula of Na-Clinoptilolite is (Na, K, Ca)₂₋₃Al₃(Al, Si)₂Si₁₃O₃₆-12H₂O. In certain hydrothermal conditions (log([Na+]/[H+])>9, log([H₄SiO₄])>−4, ph>9, Temperature>100° C., and high pressure), a mixture of Na-Clinoptilolite, gibbsite, and sodium hydroxide dissolves and re-precipitates as analcime according to the reaction:
2 Na Al Si₅O₈ (OH)₈+3Al (OH)₃+3Na(OH)+energy→5 Na Al Si₂ O₅ (OH)₂+9H₂O
Thus, it is possible to produce seeded nano-analcime particles using Na-Clinoptilolite, gibbsite, and sodium hydroxide as material precursors and analcime particles as seeds.

It may also be possible to produce seeded nano-analcime particles using Na-Clinoptilolite and nepheline as material precursors and analcine particles as seeds:
Na Al Si₅O₈ (OH)₈+3Na Al Si O₄+energy→4Na Al Si₂ O₅ (OH)₂
In the above reaction, a simplified chemical formula Na Al Si O₄ is used for nepheline. In general, nepheline has a general chemical formula (Na_{3/4}—K_{1/4})AlSiO₄.

In another embodiment, the particulate material is a mixture of seeded boehmite and precipitated silica. The process uses kaolinite, which is readily available as the boehmite and precipitated silica precursor. In acidic conditions (ph<4), temperature that can be in the range 125-175° C., and high pressure (P>10 bars), kaolinite dissolves and can reprecipitated as boehmite and silica. The dissolution precipitation reaction is summarized by the following reaction:
Al₂Si₂O₅(OH)₄+energy→2AlO(OH)+2SiO₂+H₂O
The used of amorphous silica seeds avoids the formation of crystalline silica, which represents a health hazards.

The production of nano reinforcing filler made of different primary particles is especially for the tire industry to reduce filer agglomeration tendency, which can lead to higher rolling resistance and lower wet grip.

In the context of aluminous materials, one embodiment calls for a seeded aluminum oxide-hydroxide, notably boehmite. In another embodiment, the product is a seeded alumina, particularly seeded transitional alumina such as gamma, delta, theta alumina, or combinations thereof. The material generally corresponds, with the exception of any impurities, to the formula: Al (OH)ₐO_{b}, where 0≦a≦3 and b=(3−a)/2. By way of example, when a=0 corresponds to alumina (Al₂O₃) and a=1 corresponds to boehmite. The process typically makes use of an aluminum hydroxide, such as ATH (aluminum tri-hydroxide), in forms such as gibbsite, bayerite, or bauxite, as the aluminous precursor, which is processed through seeded hydrothermal treatment. Herein, the terms “aluminous seeded particulate material” or “seeded aluminous particulate material” refer to the materials described above in this paragraph.

The particulate material, prior to incorporation into the rubber composite, may be a mass of particulate material, composed of particles that may be fully dispersed, partially agglomerated, or fully agglomerated. In dry form, the particulate material may be described as a powder. The particulate material desirably has a high disagglomeration rate, α. The disagglomeration rate a may be measured by an ultrasound disagglomeration test at 100% power of a 600-watt ultrasonic probe. In the case of aluminum oxide or hydroxide particulate materials and seeded aluminous particulate materials, the disagglomeration rate α is desirably not less than 5×10⁻³ μm⁻¹/s, and oftentimes not less than 6×10⁻³ μm⁻¹/s. Additional details regarding the measuring techniques of disagglomeration rate may be found in U.S. Pat. No. 6,610,261. The characterization technique relies on continuously measuring the evolution of the size of agglomerates during an operation to break up the agglomerates, in particular by ultrasound generation. This technique generally calls for introducing the filler into a liquid to form a homogenous liquid suspension, circulating the liquid suspension in the form of a flow through a circuit comprising breaking means which, as the flow passes, break up the agglomerates, and a laser granulometer which, at regular intervals of time “t” measures the size “d” of these agglomerates, and recording the evolution of the size d as a function of time t. The disagglomeration rate α is represented by the slope of the curve 1/d(t)=f(t) recorded by the laser granulometer, in a zone of steady state conditions of disagglomeration.

After 10 minutes of ultrasonic treatment, the agglomerate size distribution is measured. The agglomerate size distribution generally comprises 2 peaks. The 1^{st} peak corresponds to the agglomerates that are left after the ultrasonic treatment; the 2^{nd} peak corresponds to primary particles or small aggregates that can not be further desaggregated. According to the invention, the particulate materials, which exhibit a significant 2^{nd} peak after 10 minutes of ultrasonic test, are preferable. Let us consider the area AREA-1 beneath the 1^{st} peak, and the AREA-2 beneath the 2^{nd} peak. The ratio AREA-2/AREA-1 should preferably be more than 1/4, 1/2, or 1.

Typically, the morphology of the seeded aluminous particulate material is controlled to enable its use as high performance filler in the rubber composition. According to one embodiment, the aspect ratio of the particulate material, defined as the ratio of the longest dimension to the next longest dimension perpendicular to the longest dimension, is generally not less than 2:1, and preferably not less than 3:1, 4:1, or 6:1. Indeed, certain embodiments have relatively elongated particles, such as not less than 8:1, 10:1, and in some cases, not less than 14:1. With particular reference to needle-shaped particles, the particles may be further characterized with reference to a secondary aspect ratio defined as the ratio of the second longest dimension to the third longest dimension. The secondary aspect ratio is generally not greater than 3:1, typically not greater than 2:1, or even 1.5:1, and oftentimes about 1:1. The secondary aspect ratio generally describes the cross-sectional geometry of the particles in a plane perpendicular to the longest dimension. It is noted that since the term aspect ratio is used herein to denote the ratio of the longest dimension to the next longest dimension, it may be referred as the primary aspect ratio.

According to another embodiment, the particulate material can be platy, in which platelet-shaped particles generally have an elongated structure having the aspect ratios described above in connection with the needle-shaped particles. However, platelet-shaped particles generally have opposite major surfaces, the opposite major surfaces being generally planar and generally parallel to each other. In addition, the platelet-shaped particles may be characterized as having a secondary aspect ratio greater than that of needle-shaped particles, generally not less than about 3:1, such as not less than about 6:1, or even not less than 10:1. Typically, the shortest dimension or edge dimension, perpendicular to the opposite major surfaces or faces, is generally less than 50 nanometers, such as less than about 20 nanometers, or less than about 10 nanometers. Morphology of the seeded aluminous particulate material may be further defined in terms of particle size, more particularly, average particle size, as already discussed above.

The present seeded aluminous particulate material has been found to have a fine average particle size, while oftentimes competing non-seeded based technologies are generally incapable of providing such fine average particle sizes. In this regard, it is noted that oftentimes in the literature, reported particle sizes are not set forth in the context of averages as in the present specification, but rather, in the context of nominal range of particle sizes derived from physical inspection of samples of the particulate material. Accordingly, the average particle size of prior art samples will lie within the reported range in the prior art, generally at about the arithmetic midpoint of the reported range, for the expected Gaussian particle size distribution. Stated alternatively, while non-seeded based technologies may report fine particle size, such fine sizing generally denotes the lower limit of an observed particle size distribution and not average particle size.

Likewise, in a similar manner, the above-reported aspect ratios generally correspond to the average aspect ratio taken from representative sampling, rather than upper or lower limits associated with the aspect ratios of the particulate material. Oftentimes in the literature, reported particle aspect ratios are not set forth in the context of averages as in the present specification, but rather, in the context of nominal range of aspect ratios derived from physical inspection of samples of the particulate material. Accordingly, the average aspect ratio of prior art samples will lie within the reported range in the prior art, generally at about the arithmetic midpoint of the reported range for the expected Gaussian particle morphology distribution. Stated alternatively, while non-seeded based technologies may report aspect ratio, such data generally denotes the lower limit of an observed aspect ratio distribution and not average aspect ratio.

In the context of one aluminous seeded material example, processing begins with provision of a solid particulate boehmite precursor and boehmite seeds in a suspension, and heat treating (such as by hydrothermal treatment) the suspension (alternatively sol or slurry) to convert the boehmite precursor into boehmite particulate material formed of particles or crystallites. While certain embodiments make use of the as-formed hydrothermally-treated product for use as a filler, other embodiments utilize heat treatment to effect polymorphic transformation into alumina, particularly transitional alumina. According to one aspect, the particulate material (including boehmite and transitional alumina) has a relatively elongated morphology, as already described above. In addition, the morphological features associated with the boehmite are preserved in the transitional alumina particulate material.

The term “boehmite” is generally used herein to denote alumina hydrates including mineral boehmite, typically being Al₂O₃.H₂O and having a water content on the order of 15%, as well as psuedoboehmite, having a water content higher than 15%, such as 20-38% by weight. It is noted that boehmite (including psuedoboehmite) has a particular and identifiable crystal structure, and accordingly unique X-ray diffraction pattern, and as such, is distinguished from other aluminous materials including other hydrated aluminas, such as ATH (aluminum trihydroxide), a common precursor material used herein for the fabrication of boehmite particulate materials.

Turning to the details of the processes by which the seeded aluminous particulate material may be manufactured, typically an aluminous material precursor including bauxitic minerals, such as gibbsite and bayerite, are subjected to hydrothermal treatment as generally described in the commonly owned patent, U.S. Pat. No. 4,797,139. More specifically, the particulate material may be formed by combining the precursor and seeds (having desired crystal phase and composition, such as boehmite seeds) in suspension, exposing the suspension (alternatively sol or slurry) to heat treatment to cause conversion of the raw material into the composition of the seeds (in this case boehmite). The seeds provide a template for crystal conversion and growth of the precursor. Heating is generally carried out in an autogenous environment, that is, in an autoclave, such that an elevated pressure is generated during processing. The pH of the suspension is generally selected from a value of less than 7 or greater than 8, and the boehmite seed material has a particle size finer than about 0.5 microns, preferably less than 100 nm, and even more preferably less than 10 nm. In the case the seeds are agglomerated, the seed particles size refers to seed primary particles size. Generally, the seed particles are present in an amount greater than about 1% by weight of the boehmite precursor, typically at least 2% by weight, such as 2 to 40% by weight, more typically 5 to 15% by weight (calculated as Al₂O₃). Precursor material is typically loaded at a percent solids content of 60% to 98%, preferably 85% to 95%. Heating is carried out at a temperature greater than about 120° C., such as greater than about 100° C., or even greater than about 120° C., such as greater than about 130° C. In one embodiment the processing temperature is greater than 150° C. Usually, the processing temperature is below about 300° C., such as less than about 250° C. Processing is generally carried out in the autoclave at an elevated pressure such as within a range of about 1×10⁵ newtons/m² to about 8.5×10⁶ newtons/m². In one example, the pressure is autogenously generated, typically around 2×10⁵ newtons/m².

In the case of relatively impure precursor material, such as bauxite, generally the material is washed, such as rinsing with de-ionized water, to flush away impurities such as silicon and titanium hydroxides and other residual impurities remaining from the mining processes to source bauxite.

The particulate aluminous material may be fabricated with extended hydrothermal conditions combined with relatively low seeding levels and acidic pH, resulting in preferential growth of boehmite along one axis or two axes. Longer hydrothermal treatment may be used to produce even longer and higher aspect ratio of the boehmite particles and/or larger particles in general. Time periods typically range from about 1 to 24 hours, preferably 1 to 3 hours.

Following heat treatment and crystalline conversion, the liquid content is generally removed, desirably through a process that limits agglomeration of the particles of boehmite upon elimination of water, such as freeze drying, spray drying, or other techniques to prevent excess agglomeration. In certain circumstances, ultrafiltration processing or heat treatment to remove the water might be used. Thereafter, the resulting mass may be crushed, such as to 100 mesh, if needed. It is noted that the particulate size described herein generally describes the single crystallites formed through processing, rather than any aggregates that may remain in certain embodiments.

Several variables may be modified during the processing of the particulate material to effect the desired morphology. These variables notably include the weight ratio, that is, the ratio of precursor (i.e., feed stock material) to seed, the particular type or species of acid or base used during processing (as well as the relative pH level), and the temperature (which is directly proportional to pressure in an autogenous hydrothermal environment) of the system.

In particular, when the weight ratio is modified while holding the other variables constant, the shape and size of the particles forming the boehmite particulate material are modified. For example, when processing is carried at 180° C. for two hours in a 2 weight % nitric acid solution, a 90:10 ATH:boehmite ratio (precursor:seed ratio) forms needle-shaped particles (ATH being a species of boehmite precursor). In contrast, when the ATH:boehmite seed ratio is reduced to a value of 80:20, the particles become more elliptically shaped. Still further, when the ratio is further reduced to 60:40, the particles become near-spherical. Accordingly, most typically the ratio of boehmite precursor to boehmite seeds is not less than about 60:40, such as not less than about 70:30 or 80:20. However, to ensure adequate seeding levels to promote the fine particulate morphology that is desired, the weight ratio of boehmite precursor to boehmite seeds is generally not greater than about 98:2. Based on the foregoing, an increase in weight ratio generally increases aspect ratio, while a decrease in weight ratio generally decreased aspect ratio.

Further, when the type of acid or base is modified, holding the other variables constant, the shape (e.g., aspect ratio) and size of the particles are affected. For example, when processing is carried out at 180° C. for two hours with an ATH:boehmite seed ratio of 90:10 in a 2 weight % nitric acid solution, the synthesized particles are generally needle-shaped. In contrast, when the acid is substituted with HCl at a content of 1 weight % or less, the synthesized particles are generally near spherical. When 2 weight % or higher of HCl is utilized, the synthesized particles become generally needle-shaped. At 1 weight % formic acid, the synthesized particles are platelet-shaped. Further, with use of a basic solution, such as 1 weight % KOH, the synthesized particles are platelet-shaped. When a mixture of acids and bases is utilized, such as 1 weight % KOH and 0.7 weight % nitric acid, the morphology of the synthesized particles is platelet-shaped. Noteworthy, the above weight % values of the acids and bases are based on the solids content only of the respective solid suspensions or slurries, that is, are not based on the total weight % of the total weight of the slurries.

Suitable acids and bases include mineral acids such as nitric acid, organic acids such as formic acid, halogen acids such as hydrochloric acid, and acidic salts such as aluminum nitrate and magnesium sulfate. Effective bases include, for example, amines including ammonia, alkali hydroxides such as potassium hydroxide, alkaline hydroxides such as calcium hydroxide, and basic salts.

Still further, when temperature is modified while holding other variables constant, typically changes are manifested in particle size. For example, when processing is carried out at an ATH:boehmite seed ratio of 90:10 in a 2 weight % nitric acid solution at 150° C. for two hours, the crystalline size from XRD (x-ray diffraction characterization) was found to be 115 Angstroms. However, at 160° C. the average particle size was found to be 143 Angstroms. Accordingly, as temperature is increased, particle size is also increased, representing a directly proportional relationship between particle size and temperature.

According to embodiments described herein, a relatively powerful and flexible process methodology may be employed to engineer desired morphologies into the particulate material. Of particular significance, embodiments utilize seeded processing resulting in a cost-effective processing route with a high degree of process control which may result in desired fine average particle sizes as well as controlled particle size distributions. The combination of (i) identifying and controlling key variables in the process methodology, such as weight ratio, acid and base species and temperature, and (ii) seeding-based technology is of particular significance, providing repeatable and controllable processing of desired particulate material morphologies.

As noted above, the as-formed hydrothermally processed particulate material may be used as the reinforcing filler in certain embodiments, while in other embodiments, processing may continue to form a converted form of filler. In this case, the hydrothermally processed particulate material forms the feedstock material that may be further heat treated. In the case of boehmite particulate material from hydrothermal processing, further thermal treatment causes conversion to transitional alumina. Here, the boehmite feedstock material is heat treated by calcination at a temperature sufficient to cause transformation into a transitional phase alumina, or a combination of transitional phases. Typically, calcination or heat treatment is carried out at a temperature greater than about 250° C., but lower than 1100° C. At temperatures less than 250° C., transformation into the lowest temperature form of transitional alumina, gamma alumina, typically will not take place. At temperatures greater than 1100° C., typically the precursor will transform into the alpha phase, which is to be avoided to obtain transitional alumina particulate material. According to certain embodiments, calcination is carried out at a temperature greater than 400° C., such as not less than about 450° C. The maximum calcination temperature may be less than 1050 or 1100° C., these upper temperatures usually resulting in a substantial proportion of theta phase alumina, the highest temperature form of transitional alumina.

Other embodiments are calcined at a temperature lower than 950° C., such as within a range of 750 to 950° C. to form a substantial content of delta alumina. According to particular embodiments, calcination is carried out at a temperature less than about 800° C., such as less than about 775° C. or 750° C. to effect transformation into a predominant gamma phase.

Calcination may be carried out in various environments including controlled gas and pressure environments. Because calcination is generally carried out to effect phase changes in the precursor material and not chemical reaction, and since the resulting material is predominantly an oxide, specialized gaseous and pressure environments need not be implemented except for most desired transitional alumina end products.

However, typically, calcination is carried out for a controlled time period to effect repeatable and reliable transformation from batch to batch. Here, most typically shock calcination is not carried out, as it is difficult to control temperature and hence control phase distribution. Accordingly, calcination times typically range from about 0.5 minutes to 60 minutes typically, 1 minute to 15 minutes.

Generally, as a result of calcination, the particulate material is mainly (more than 50 wt %) transitional alumina. More typically, the transformed particulate material was found to contain at least 70 wt %, typically at least 80 wt %, such as at least 90 wt % transitional alumina. The exact makeup of transitional alumina phases may vary according to different embodiments, such as a blend of transitional phases, or essentially a single phase of a transitional alumina (e.g., at least 95 wt %, 98 wt %, or even up to 100 wt % of a single phase of a transitional alumina).

According to one particular feature, the morphology of the boehmite feedstock material is largely maintained in the final, as-formed transitional alumina. Accordingly, desirable morphological features may be engineered into the boehmite according to the foregoing teaching, and those features preserved. For example embodiments have been shown to retain at least the specific surface area of the feedstock material, and in some cases, increase surface area by amount of at least 8%, 10%, 12%, 14% or more.

In the context of seeded aluminous particulate material, particular significance is attributed to the seeded processing pathway, as not only does seeded processing to form seeded particulate material allow for tightly controlled morphology of the precursor (which is largely preserved in the final product), but also the seeded processing route is believed to manifest desirable physical properties in the final product, including compositional, morphological, and crystalline distinctions over particulate material formed by conventional, non-seeded processing pathways.

In addition to the filler, the rubber composition includes one or more coupling agents. Typically, a coupling agent includes at least one rubber reactive functional group that is reactive with the elastomer and includes at least one filler reactive functional group that is reactive with the filler. Generally, the coupling agent may establish a chemical and/or physical connection between the reinforcing filler and the elastomer. In addition, the coupling agent may facilitate dispersion of the filler within the elastomer.

In one particular embodiment, the coupling agent includes a segment having the general formula Y-T-X in which Y represents functional groups that are capable of bonding with the reinforcing filler, X represents functional groups that are capable of bonding with the elastomer, and T represents groups that link X and Y. In one exemplary embodiment, the coupling agent may conform to the general formula Y-T-X—R in which R is any group that is functional or not functional. In another exemplary embodiment, the coupling agent conforms to the general formula Y₁-T₁-X-T₂-Y₂ in which T₁ and T₂ may be the same group or different groups and in which Y₁ and Y₂ may be the same functional group or different functional groups. Other general formulas useful in forming coupling agents with more than one functional group for reacting with the elastomer or the filler include (Yi-Ti)_{1≦i≦n}-X; Y-(Ti-Xi)_{1≦i≦n}; and (Yi)_{1≦i≦n}-T-(Xj)_{1≦j≦m}, in which n and m are integers greater than zero.

Generally, the X group is a rubber reactive functional group that is reactive with the elastomer. For example, the X group may include sulfur or an unsaturated carbon-carbon bond that can react with the elastomer when subjected to temperature, in the presence of sulfur, or with the help of catalysts, such as peroxides. In one exemplary embodiment, the X group includes sulfur, such as polysulfides, xanthanate groups, thiocarbonate groups, thiocarbamate groups, thioacetate groups, mercaptol groups, and mercaptan. Exemplary polysulfides include disulfide, trisulfide, and tetrasulfide groups. Thiocabonates include dithiocarbonate and trithiocarbonate groups. Thiocarbamate groups include monothiocarbamate and dithiocarbamate and thioacetate groups include thioacetate and dithioacetate groups. In another example, the X group includes mercaptol. In a further exemplary embodiment, the X group includes amine sulfides, such as amine disulfide.

In one particular embodiment, when the X group resides on a terminal end of the coupling agent, such as an agent conforming to the formula Yₙ-T-X in which n is an integer greater than zero, the X group may include mercaptan or a vinyl terminal group, such as found in acrylate and methacrylate functional groups, among others.

Generally, the Y group is a filler reactive functional group that is reactive with filler. In one exemplary embodiment, the Y group includes phosphorus. For example, the Y group may include at least one phosphato or pyrophosphato group. Exemplary embodiments of phosphorus-based Y groups include phosphonic acid groups, phosphinic acid groups, phosphoric acid monoester groups, phosphoric acid di-ester groups, and derivatives thereof. For example, the Y group may conform to the formulas phosphonic acid: (OH)₂ P(O)—R; phosphinic acid: (OH)₁ P(O)-(Ri)_{1≦i≦2}; phosphoric acid monoester: (OH)₂ P(O)—O—R; and phosphoric acid diester: (OH)₁ P(O)—(O-Ri)_{1≦i≦2} wherein (O) represent a P═O double bond. In one example, the Y group may be phosphonic acid, or phosphinic acid with monovalent cations substituted in place of the hydrogens. In another example, the Y group may include ester derivatives of phosphonic acid or phosphinic in which esters are formed of alkyl groups, such as methyl, ethyl and propyl groups, aryle groups and are substituted in place of the hydrogens of the OH groups. In a further example, the Y group includes phosphonic acid and derivatives of phosphonic acid with trialkylsilyle groups or trialkylamino groups substituted in place of the hydrogens of the OH groups. In another exemplary embodiment, the Y group includes phosphoric acid monoesters and phosphoric acid diester. As described above, OH groups may be replaced with ester groups, such as trialkylsilyle, trialkylamino, or alkylate substituted by a monovalent cation.

In one exemplary embodiment, the Y group includes a sulfonic group and derivatives thereof, as described above. For example, the Y group may conform to the formula of a sulfur based acid: (OH)₁ S(O)_{3-z}—R wherein (O) represent a S═O double bond and z equals 1 or 2. In another exemplary embodiment, the Y group includes titanium, such as titanate groups or groups including at least one titanium atom linked to oxygen atoms. In a further exemplary embodiment, the Y group includes zirconium, such as zirconate and functional groups including at least one zirconium atom linked to oxygen atoms. In another embodiment, the Y group includes aluminum, such as aluminates, alumino zirconates, and alumino silicates. In addition, the Y group may include a derivative of titanate, zirconate, or aluminate, as described above.

If the coupling agent contains a single type of Y filler reactive functional group, this particular Y group may be non-silyl or free of silicon atoms. However when the coupling agent comprises more than one type of Y filler reactive functional groups, or it made of several different chemical compounds having different group Y, it is possible that a fraction (less than 90%) of the Y groups are silane coupling agents. In particular, a fraction (more than 10%) of the Y groups that are attached to the filler in the final product should not be silane coupling agents. This can be check for example by NMR. A significant portion (more than 10%) of the group Y attached to the filler in the final product should include one or more atoms selected from the group consisting of sulfur, titanium, zirconium, or aluminum.

The T group generally links a Y group to an X group. Exemplary embodiments of T groups include alkyl groups, such as methyl, ethyl and propyl groups, and aryl groups.

In further embodiments, the coupling agent includes polysulfide derivatives of phosphonic acid, phosphinic acid, and phosphoric acid. For example, the coupling agent may include disulfides, trisulfide, and tetrasulfide organophosphonic acid and organophosphonates substituted by a monovalent cation. Exemplary embodiments include bis-(phosphonic acid propyl)tetrasulfide, bis-(phosphonic acid propyl)polysulfide, bis-(diethylphosphonate propyl)tetrasulfide, bis-(diethylphosphonate propyl)disulfide, bis-(disodium phosphonate ethyl)disulfide, and dithioester phosponate derivatives. Other exemplary coupling agents include trialkylsilylphosphonate alkylpolysulfides and trialkylsilylphosphonate estersulfides. Particular coupling agent embodiments include the formulas (EtO)₂P(O)—(CH₂)₃—S₄—(CH₂)₃—P(O)(EtO)₂, (Me₃SiO)₂P(O)—((CH₂)₃—S₄—(CH₂)₃—P(O)(OSiMe₃)₂, (HO)₂P(O)—(CH₂)₃—S₄—(CH₂)₃—P(O)(OH)₂, (EtO)₂P(O)—O(CH₂)₃—S₄—(CH₂)₃O—P(O)(EtO)₂, (EtO)₂P(O)—(CH₂)₃—S₂—(CH₂)₃—P(O)(EtO)₂, (Me₃SiO)₂P(O)—((CH₂)₃—S₂—(CH₂)₃—P(O)(OSiMe₃)₂, (HO)₂P(O)—(CH₂)₃—S₂—(CH₂)₃—P(O)(OH)₂, and (EtO)₂P(O)—O(CH₂)₃—S₂—(CH₂)₃O—P(O)(EtO)₂, wherein Et represents an ethyl group, Me represent a methyl group, and P(O) represents a phosphorous atom with a double bonded oxygen. A further exemplary embodiment includes a coupling agent having the formula R—S—C(O)—S—P(O)(OH)₂, wherein C(O) represents a carbon atom double bonded to oxygen.

In another exemplary embodiment, the coupling agent includes polysulfides of sulfonic acid derivatives. For example, the coupling agent includes bis-(3-sulfonic acid propyl)polysulfide and monovalent cation substituted derivatives thereof. Exemplary embodiments are represented by the formula (HO)S(O)₂—(CH₂)₃—Sₙ—(CH₂)₃—S(O)₂(OH), (MO)S(O)₂—(CH₂)₃—Sₙ—(CH₂)₃—S(O)₂(OM), wherein n is an integer greater than 1 and M represents a monovalent cation.

The coupling agent may be made of a single chemical compound, or a mixture of several different chemical compounds.

The coupling agent may be incorporated into the rubber composition in amounts 10⁻⁷ to 10⁻⁵ moles/m², such about 2×10⁻⁷ to about 5×10⁻⁶ moles/m² based on the surface area of the filler. When the coupling agent includes more than one functional group of a given type, such as Y functional groups and X functional groups, the amount of coupling agent may be lower, such as not more than about 2×10⁻⁶ moles/m². Generally, it is desired that the filler particulate product have a high density of OH groups, between about 10⁻⁷ and 10⁻⁵ moles/m², such as 2×10⁻⁷ to 5×10⁻⁶ moles/m². Herein, m² represents the CTAB surface area. Thus, if, for example, the reinforcing filler as a CTAB surface area of 130 m²/g, the quantity of coupling agent should be between 130×10⁻⁷ and 130×10⁻⁵ moles/gram of filler. When the coupling agent has multiple functional groups Y that can bond to the reinforcing filler, the quantity of coupling agent should be preferably less than 2×10⁻⁶ moles/m2.

In another embodiment, coupling agents have the general formulas Y Rm Zn, in which Y represents a functional group capable of bonding with the reinforcing filler, “n” is an integer equal to 1, 2 or 3, and “m” is an integer equal to 0, 1, or 2 (the sum of n and m should be equal to 1, 2, 3 or 4). The groups Zn represent functional groups attached to Y are capable of bonding with the rubber or plastic compound. The groups Z can be the same or different. The groups Rm represent non functional groups attached to Y. The groups R can be the same or different

The rubber composition may be formed by mixing each of the elastomer precursors, filler, and coupling agent at the time of formulation. Alternatively, the rubber composition may be formed by first forming an elastomeric reactive or rubber reactive filler by mixing the filler and coupling agent, and mixing the elastomer reactive filler with the elastomer precursors.

In an exemplary method, particulate filler and coupling agent are mixed to form a mixture. The particulate filler, for example, includes nano-particulate seeded aluminous filler and the coupling agent, which includes for example a disulfides group, or an unsaturated carbon-carbon bond. The mixture is dried to form an elastomer reactive filler, such as through drying processes that limit agglomeration. For example, the mixture is dried by freeze drying or spray drying. A soft drying process at lower temperature is preferred if the coupling agent comprises a rubber functional group, such as tetrasulfide group, that is sensitive to temperature.

The elastomer reactive filler is added to elastomeric precursors and the precursors are cured to form the rubber composition. For example, the elastomeric precursors may be vulcanized, such as sulfur cured or peroxide cured. The reactive functional groups on the coupling agent typically bond to sites on the elastomeric precursors.

In another embodiment, the coupling agent is added together with the untreated filler to the rubber formulation during the mixing process before curing. Usually the mixing process is performed using a conventional internal mixer. The constituents are added together with the exception of the vulcanization system. A second step may be added with the aim to subject the mix to additional thermomechanical treatment. The result of the first mixing step is then taken up on an external mixer generally an open mill, and the vulcanization system is added.

In a further embodiment, the filler are first treated with a coupling agent CA-1 before the mixing process, and then added in conjunction with another coupling agent CA-2 to the rubber formulation during the mixing process. CA-1 and CA-2 can be the same or different.

In another embodiment, the disclosure is directed to a rubber formulation comprising particles, which correspond, with the exception of any impurities, to the general formula Mₓ A_{y} Si_{z} O_{b} (OH)ₐ (H₂O)_{c} (X)_{d} where
x≧0, y≧0, z≧0, a≧0, b≧0, (a+b)>0, c≧0, d≧0,
M being selected from the group comprising Na+, K+, Ca++, Mg++, Ba++ or a mixture of this cations,
A being selected from the group comprising Al, Sn, In, Sb, transition metals, or a mixture of these metals,
X being selected from the group comprising F⁻, Cl⁻, Br⁻, I⁻, CO3⁻², SO4⁻², PO4⁻³, NO₃⁻, other anions, or a mixture of these anions,

and a coupling agent having a polysulfide functional group and having at least one functional group selected from a group consisting of phosphonic acid, phosphinic acid, phosphoric acid monoester, phosphoric acid diester, sulfonic acid, and derivatives thereof.

In one particular embodiment, the disclosure is directed to a rubber composition including nano-particulate filler having a BET specific area at least about 25 m²/g and having a composition that includes the element oxygen and at least one element selected from the group comprising Al, Sn, In, Sb, Mg, transition metals, or a mixture of these elements. The rubber composition also includes a coupling agent that includes at least one rubber reactive functional group and at least one filler reactive functional group. The rubber reactive functional group includes one or more atoms selected from the group consisting of phosphorous, sulfur, titanium, zirconium, or aluminum.

In another embodiment, the disclosure is directed to a rubber composition comprising nano-particulate filler and a coupling agent that includes at least one rubber reactive functional group and at least one filler reactive functional group.

In one embodiment, the disclosure is direct to a rubber composition comprising particulate filler and a coupling agent having at least one rubber reactive functional group having at least one sulfur or one unsaturated carbon-carbon bond.

In another exemplary embodiment, the disclosure is directed to a rubber formulation comprising particles containing aluminum and a coupling agent having a polysulfide functional group and having at least one functional group selected from a group consisting of phosphonic acid, phosphinic acid, phosphoric acid monoester, phosphoric acid diester, sulfonic acid, and derivatives thereof.

In a further exemplary embodiment, the disclosure is directed to a rubber formulation comprising seeded aluminous oxide-hydroxide particles and a coupling agent having a polysulfide functional group and having at least one functional group selected from a group consisting of phosphonic acid, phosphinic acid, phosphoric acid monoester and diester, sulfonic acid, and derivatives thereof.

In a further exemplary embodiment, the disclosure is directed to a rubber formulation comprising aluminous particles and a coupling agent including a sulfonic functional group.

In another exemplary embodiment, the disclosure is directed to a rubber formulation comprising nano-particulate seeded aluminous material and a coupling agent having a phosphorous-based filler reactive functional group.

In a further exemplary embodiment, the disclosure is directed to a rubber formulation comprising aluminous particles and a coupling agent comprising a phosphonic acid functional group and a sulfide functional group.

In another exemplary embodiment, the disclosure is directed to a rubber formulation comprising particles and a coupling agent having a titanate functional group.

In a further exemplary embodiment, the disclosure is directed to a rubber formulation comprising particles and a coupling agent having a zirconate functional group.

In another exemplary embodiment, the disclosure is directed to a rubber formulation comprising particles and a coupling agent having a titanate or zirconate group, and a phosphorus-containing group.

In a further exemplary embodiment, the disclosure is directed to a method of manufacturing rubber formulations. The method includes mixing nano-particulate filler with a coupling agent and drying the mixture to form a rubber reactive filler.

In another exemplary embodiment, the disclosure is directed to a method of forming a rubber composition. The method includes mixing diene precursors, nano-particulate filler, and a coupling agent to form a mixture and curing the mixture.

Particular embodiments of the above described rubber compositions provide advantageous features. For example, rubber compositions include seeded aluminous particulate materials and coupling agents, such as alkylpolysulfide derivatives of phosphonic acid and alkylpolysulfide derivatives of sulfonic acid, provide low rolling resistance, leading to lower gas consumption. Such rubber compositions provide adhesion in wet conditions and, thus provide for safety. Such rubber compositions also provide for service life and wear resistance.

In particular, embodiments of the above described rubber composition may exhibit improved wear resistance. Additional embodiments of the above described rubber composition may exhibit improved adhesion to surfaces in wet conditions. Such improvements in wear resistance and adhesion may be attributed to elastomers including high aspect ratio aluminous materials, such as high aspect ratio boehmite particulate, and particular coupling agents.

While the invention has been illustrated and described in the context of specific embodiments, it is not intended to be limited to the details shown, since various modifications and substitutions can be made without departing in any way from the scope of the present invention. For example, additional or equivalent substitutes can be provided and additional or equivalent production steps can be employed. As such, further modifications and equivalents of the invention herein disclosed may occur to persons skilled in the art using no more than routine experimentation, and all such modifications and equivalents are believed to be within the scope of the invention as defined by the following claims.

1. A rubber composition comprising nano-particulate filler and a coupling agent that includes at least one rubber reactive functional group and at least one filler reactive functional group, wherein the filler reactive functional group includes one or more atoms selected from the group consisting of sulfur, titanium, zirconium, and aluminum.

2. The rubber composition of claim 1, further comprising a curable elastomer.

3. The rubber composition of claim 2, wherein the curable elastomer is a diene elastomer.

4.-5. (canceled)

6. The rubber composition of claim 1, wherein the particulate filler has a composition, which includes the element oxygen and at least one element selected from the group consisting of Al, Sn, In, Sb, Mg, transition metals, and a mixture of these elements.

7.-9. (canceled)

10. The rubber composition of claim 1, wherein the nano-particulate filler comprises aluminum.

11. The rubber composition of claim 10, wherein the nano-particulate filler comprises aluminum oxide-hydroxide material.

12. The rubber composition of claim 11, wherein the aluminum oxide-hydroxide material that has the formula Al(OH)ₐO_{b}, with the exception of any impurities, wherein 0≦a≦3 and b=(3−a)/2.

13.-31. (canceled)

32. The rubber composition of claim 1, wherein the nano-particulate filler has an aspect ratio of not less than 2:1.

33.-35. (canceled)

36. The rubber composition of claim 1, wherein the nano-particulate filler has an average particle size not greater than 1000 nm.

37.-42. (canceled)

43. The rubber composition of claim 1, wherein the at least one rubber reactive functional group includes sulfur.

44.-47. (canceled)

48. The rubber composition of claim 1, wherein the at least one rubber reactive functional group comprises a functional group with an unsaturated carbon/carbon bond.

49.-50. (canceled)

51. The rubber composition of claim 1, wherein the filler reactive functional group comprises an acid derivative of titanate, zirconate, sulfonate, or aluminate.

52.-54. (canceled)

55. The rubber composition of claim 1, wherein the at least one filler reactive group comprises a sulfonic acid group.

56. The rubber composition of claim 1, wherein the at least one filler reactive group comprises a titanate group.

57. The rubber composition of claim 1, wherein the at least one filler reactive group comprises a zirconate group.

58. (canceled)

59. The rubber composition of claim 1, wherein the rubber composition includes the coupling agent in an amount of about 10⁻⁷ to about 10⁻⁵ moles/m² based on the surface area of the filler.

60.-61. (canceled)

62. A rubber formulation comprising aluminous particles and a coupling agent including a sulfonic filler reactive functional group.

63. The rubber formulation of claim 62, wherein the aluminous particles are seeded aluminous particles.

64.-65. (canceled)

66. The rubber formulation of claim 62, wherein the coupling agent includes a polysulfide functional group.

67.-68. (canceled)

69. A rubber formulation comprising aluminous particulate filler and a coupling agent having a titanate functional group.

70.-83. (canceled)
